(19) United States
(12) Patent Application Publication
(10) Pub. No.: US 2011/0199203 A1
(43) Pub. Date: Aug. 18, 2011

(54) TEMPERATURE SENSING LIGHT-EMITTING DEVICE

(76) Inventor: Chia-Ho Hsu, Sanchong City (TW)

(21) Appl. No.: 12/885,149

(22) Filed: Sep. 17, 2010

(30) Foreign Application Priority Data
Feb. 12, 2010 (TW) 099202898

(51) Int. Cl. B60Q 1/00; G01K 1/02; G06F 15/00; G10L 21/00

(52) U.S. Cl. 340/449; 702/130; 704/270

(57) ABSTRACT

The present invention provides a temperature sensing light-emitting device, applicable for use in electronic devices, and is structured from a temperature sensing element, a processing unit, a display element, and a voice unit. The temperature sensing element is used to sense the temperature of the area under measurement, after which the electrically connected processing unit determines the measured temperature. The present invention is characterized in that the processing unit is connected to the display element, thereby enabling the measured temperature to be visually displayed for the user; and the temperature sensing element is used to sense the temperature of the area under measurement after which the processing unit determines the temperature range of the area under measurement to adjust the display element to display different color lights, thereby enabling the user to easily determine the temperature of the area under measurement.

### BACKGROUND OF THE INVENTION

(a) Field of the Invention

The present invention provides a temperature sensing light-emitting device applicable for use in electronic devices, more particularly, after sensing a temperature, the temperature sensing light-emitting device is able to display different color lights corresponding to different temperatures, while at the same time emits a voice sound effect as a caution calling attention to the user. The electronic devices can be manned vehicles, such as automobiles or motorcycles, portable electronic devices, such as wristwatches, and so on.

(b) Description of the Prior Art

In thermometer technology of the prior art, in order to improve the convenience of reading the numerals, thermometers were changed to enable sensing and displaying the temperature by electronic means to facilitate the convenience in reading the numerals for the user.

Furthermore, in order to improve the sensing time, a temperature sensing element was added to the electronic display thermometer to enable using electronic sensing technology to reduce the time in sensing temperature.

However, an inconvenience still exists in thermometers with electronic sensing displays, which is that the user must read the numerals being displayed on the display, the user being unable to directly perceive and determine the measured temperature through the senses. For this reason, reading the numerals on a thermometer is an extremely demanding matter for some visually impaired persons.

Hence, based on many years engaged in research and extensive practical experience, the inventor of the present invention, having carried out research and design and specialized indepth study from many perspectives, proposes a temperature sensing light-emitting device as disclosed in the present invention as a means and basis to realize an improvement in the prior art.

### SUMMARY OF THE INVENTION

In light of the aforementioned issues, the objective of the present invention is to provide a temperature sensing light-emitting device that uses a temperature sensing element to sense the temperature of an area under measurement, whereupon a processing unit determines the measured temperature, which is then displayed on a connected display element. Moreover, a processing unit is used to determine the temperature range of the area under measurement and adjust the display element to display different color lights accordingly, thereby enabling the user to easily determine the temperature of the area under measurement.

The primary objective of the present invention lies in providing a temperature sensing light-emitting device for use in electronic devices, which enables the user to involuntary perceive temperature values using a display element and a voice unit. A temperature sensing element is used to sense the temperature of an area under measurement, after which an electrically connected processing unit determines the measured temperature, whereupon the display element receives electronic signals from the processing unit and displays numerals in color light correspondingly matching the measured temperature for the user to read. In addition, the voice unit also receives electronic signals from the processing unit and emits a voice sound effect correspondingly matching the measured temperature as a caution calling attention to the user.

Based on the aforementioned, because the temperature sensing light-emitting device of the present invention not only uses the display element to receive electronic signals from the processing unit and display numerals in color light correspondingly matching the measured temperature for the user to read, thereby facilitating the user to read the displayed numerals by first directly viewing the displayed color lights to perceive the measured temperature, but also uses the voice unit to receive electronic signals from the processing unit and emit a voice sound effect correspondingly matching the measured temperature as a caution calling attention to the user, thereby similarly enabling the user to involuntary perceive the measured temperature.

In addition, apart from being applied in thermometers, the temperature sensing light-emitting device of the present invention can similarly be applied in various devices requiring temperature sensing, such as engines of manned vehicles, including automobiles, motorcycles or airplanes; portable electronic devices, such as mobile phones, wristwatches, and so on.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational schematic view depicting a temperature sensing light-emitting device of the present invention.

FIG. 2 is an exploded elevational schematic view of the temperature sensing light-emitting device of the present invention.

FIG. 3 is an elevational schematic view depicting another embodiment of the temperature sensing light-emitting device of the present invention.

### DETAILED DESCRIPTION OF THE PREFERRED EMBODIMENTS

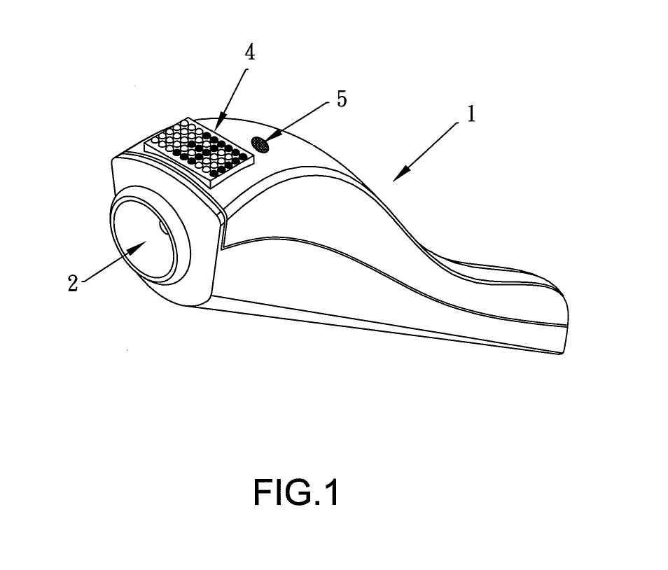

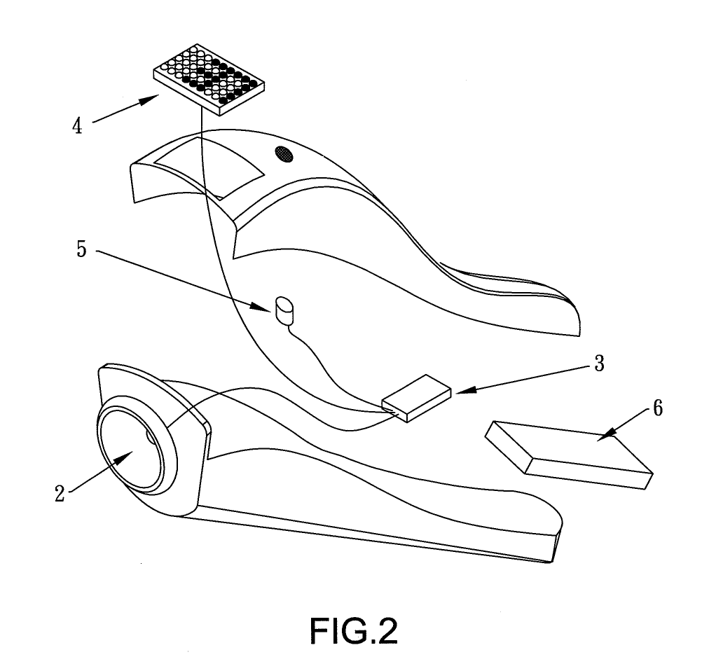

Referring together to FIG. 1 and FIG. 2, which show an elevational schematic view and an exploded elevational schematic view respectively of a temperature sensing light-emitting device of the present invention, in which the temperature sensing light-emitting device of the present invention is applicable for use in electronic devices. A non-contact thermometer is taken as an example of an electronic device in the embodiments, in which the non-contact thermometer is provided with a main body 1, and the main body 1 comprises a temperature sensing element 2, a processing unit 3, a display element 4, a voice unit 5 and a power supply unit 6, in which the power supply unit 6 is electrically connected to the temperature sensing element 2, the processing unit 3, the display element 4, and the voice unit 5, thereby providing working voltage to each of the aforementioned components. In addition, apart from a battery power supply serving as the power supply unit 6, any type of solar energy generating device can also serve as the power supply unit 6.

The temperature sensing element 2 can be either a contact or a non-contact temperature sensor, and is used to sense the temperature of an area under measurement, whereby a difference in temperature of the area under measurement causes the temperature sensing element 2 to produce a different signal accordingly. The processing unit 3 is electrically connected to the temperature sensing element 2 to enable receiving signals from the temperature sensing element 2, and the signals are used to calculate the temperature of the area under measurement.

The display element 4 is structured from at least one gradient color changing multicolor light-emitting diode, or a plurality thereof arranged in a matrix fashion according to the size of the electronic device in which the temperature sensing light-emitting device is being used. Moreover, the display element 4 is electrically connect to the processing unit 3, thereby enabling receiving electronic signals from the processing unit 3, and the display element 4 displays the measured temperature of the area under measurement in the form of numerals or letters, the gradient color changing multicolor light-emitting diodes being used to simultaneously display the numerals or letters in color light correspondingly matching the measured temperature. For example, when the temperature is higher than some certain value, then there is a gradient color change in the multicolor light-emitting diodes, and a red light is emitted, whereas, when the temperature is lower than another predetermined value, then there is a gradient color change in the multicolor light-emitting diode, and a blue light is emitted. In addition, the display element 4 can be additionally fitted with a backlit panel (not shown in the drawings), thereby increasing the definition of the display element 4.

The voice unit 5 can be a voice speaker, which is electrically connected to the processing unit 3, thereby enabling receiving electronic signals from the processing unit 3, whereupon a preset voice is played correspondingly matching the measured temperature value of the area under measurement, while at the same time emitting a cautionary sound to call attention to the user.

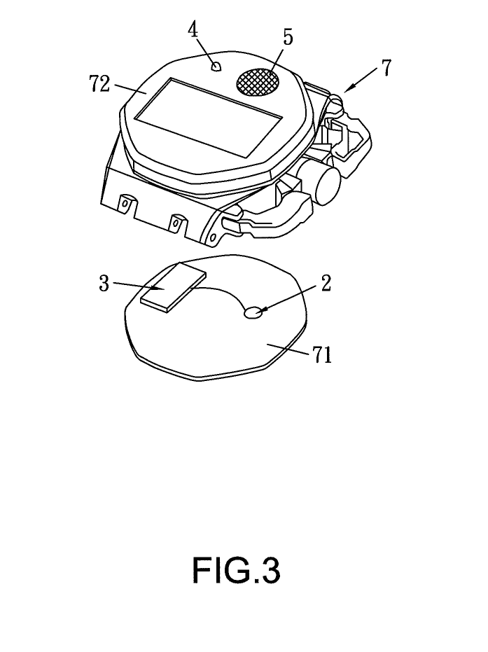

Referring to FIG. 3, which shows an implementation schematic view of another embodiment of the temperature sensing light-emitting device according to the present invention, in which the drawing depicts an embodiment of the temperature sensing light-emitting device of the present invention applied in an electronic watch. The temperature sensing element 2 is mounted on a base plate 71 of an electronic watch 7, and the display element 4 and the voice unit 5 are mounted on the surface 72 of the electronic watch 7. When the user wears the electronic watch 7, the base plate 71 comes in contact with the user, thereby enabling the temperature sensing element 2 to sense the body temperature of the user through the base plate 71.

In addition, the temperature sensing light-emitting device of the present invention can be also used in some other situations. For example, when a temperature sensing element is fitted to an engine of an automobile or motorcycle, and a display element and a voice unit are mounted on the instrument panel of the automobile or motorcycle, then they can be used to sense the temperature of the engine and call attention to the user, or the temperature sensing light-emitting device of the present invention can be installed to a clock, and a temperature sensing element fitted to the outer casing of the clock to sense the ambient temperature, and so on.

From the aforementioned description it can be understood that a display element and a voice unit can be used to perceive the temperature of an area under measurement using voice and visual perception, thereby improving the convenience of reading the temperature of an area under measurement by the visually impaired person.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A temperature sensing light-emitting device, applicable for use in electronic devices, the temperature sensing light-emitting device comprises at least:
a temperature sensing element, wherein the temperature sensing element is able to sense the temperature of an area under measurement; and
a processing unit, wherein the processing unit is electrically connected to the temperature sensing element to determine the measured temperature;
wherein the processing unit is connected to a display element, thereby providing a visual display of the measured temperature for the user; the temperature sensing element is used to sense the temperature of the area under measurement, after which the processing unit determines the temperature range of the area under measurement to adjust the display element to display different color lights, thereby enabling the user to easily determine the temperature of the area under measurement.

2. The temperature sensing light-emitting device according to claim 1, wherein the display element is assembled from a plurality of light-emitting diodes arranged in a matrix fashion to enable displaying numerals or words.

3. The temperature sensing light-emitting device according to claim 1, wherein the display element is configured as a backlit panel.

4. The temperature sensing light-emitting device according to claim 1, wherein the temperature sensing light-emitting device is fitted with a power supply unit.

5. The temperature sensing light-emitting device according to claim 4, wherein the power supply unit is either a battery or a solar energy generating device.

6. The temperature sensing light-emitting device according to claim 1, wherein the temperature sensing element is either a contact or a non-contact temperature sensing element.

7. The temperature sensing light-emitting device according to claim 1, wherein the electronic device is a manned vehicle, including an automobile or a motorcycle.

8. The temperature sensing light-emitting device according to claim 1, wherein the electronic device is a portable electronic device, including a wristwatch.

9. The temperature sensing light-emitting device according to claim 1, wherein the electronic device is a clock.

10. A temperature sensing light-emitting device, wherein applicable for use in electronic devices, the temperature sensing light-emitting device comprises at least:
a temperature sensing element, wherein the temperature sensing element is able to sense the temperature of an area under measurement; and
a processing unit, wherein the processing unit is electrically connected to the temperature sensing element to determine the measured temperature;
wherein the processing unit is connected to a display element and a voice unit, thereby enabling the measured temperature to be processed and revealed visually and by voice to the user; the temperature sensing element is used to sense the temperature of the area under measurement, after which the processing unit determines the temperature value of the area under measurement to adjust the display element to display different color lights, while at the same time revealing the temperature value by voice, thereby enabling the user to easily to determine the temperature of the area under measurement.

11. The temperature sensing light-emitting device according to claim 10, wherein the voice unit is a voice speaker.

12. The temperature sensing light-emitting device according to claim 10, wherein the display element is assembled from a plurality of light-emitting diodes arranged in a matrix fashion to enable displaying numerals or words.

13. The temperature sensing light-emitting device according to claim 10, wherein the display element is configured as a backlit panel.

14. The temperature sensing light-emitting device according to claim 10, wherein the temperature sensing light-emitting device is fitted with a power supply unit.

15. The temperature sensing light-emitting device according to claim 14, wherein the power supply unit is either a battery or a solar energy generating device.

16. The temperature sensing light-emitting device according to claim 10, wherein the temperature sensing element is either a contact or a non-contact temperature sensing element.

17. The temperature sensing light-emitting device according to claim 10, wherein the electronic device is a manned vehicle, including an automobile or a motorcycle.

18. The temperature sensing light-emitting device according to claim 10, wherein the electronic device is a portable electronic device, including a wristwatch.

19. The temperature sensing light-emitting device according to claim 10, wherein the electronic device is a clock.
